(19) United States
(12) Patent Application Publication
(10) Pub. No.: US 2018/0005456 A1
(43) Pub. Date: Jan. 4, 2018

(54) SYSTEM AND METHOD FOR GENERATING PHOTOREALISTIC VISUALS OF A CUSTOMIZED SCENARIO

(71) Applicant: House of Blue Beans Interactive Media Pvt. Ltd., Bangalore (IN)

(72) Inventors: Kaushik Vijayaraghavan, Bangalore (IN); Keshav Vijayaraghavan, Bangalore (IN)

(21) Appl. No.: 15/638,752

(22) Filed: Jun. 30, 2017

(30) Foreign Application Priority Data
Jun. 30, 2016 (IN) 201641022515

(51) Int. Cl. G06T 19/20; G06F 17/30; G06T 15/50

(52) U.S. Cl. CPC G06T 19/20; G06T 15/506; G06F 17/3028; G06F 17/30268; G06T 2200/24; G06T 2210/04

(57) ABSTRACT

Method and system for generating photorealistic visuals (image, video or GIF) of a customized scenario are disclosed according to some aspects of the present invention. The user activates a Customizer on a communication device and selects inspirational 3D models to add assets to create the customized scenario. The specific inputs are provided and assets 3D models are edited by the user to finalize the customized scenario. The customized scenario is then converted to photorealistic visual by an Image Generator by creating a replica of the customized scenario.

### RELATED APPLICATION AND PRIORITY CLAIM

The present disclosure claims priority from co-pending India Provisional patent application having the title “SYSTEM AND METHOD FOR GENERATING PHOTOREALISTIC VISUALS OF A CUSTOMIZED SCENARIO”, assigned Application Number: 201641022515, Filed on: 30 Jun. 2016 and co-pending India non-Provisional application having the title “SYSTEM AND METHOD FOR GENERATING PHOTOREALISTIC VISUALS OF A CUSTOMIZED SCENARIO”, assigned Application Number: 201641022515, Filed on: 29 Jun. 2017, both the co-pending applications being incorporated in their entirety into the present application, to the extent not inconsistent with the disclosure herein.

### FIELD OF THE INVENTION

The invention relates to generating visuals, and in particular to generating photorealistic visuals of a customized scenario.

### BACKGROUND OF THE INVENTION

The use of interactive and dynamic 3D computer graphics is becoming prevalent in the computing world. In online commerce industry the use of interactive visualization tools is increasing to provide rich experience to consumers. The consumers can view photorealistic images of desired products on their web browsers and can make a more informed and accurate purchase decision. This has significant importance for online business of products like furniture, apparels, wall paper, rugs, etc.

The current technology allows the consumer to interactively customize the environment setup, however, the photorealistic visuals are generated manually by high skilled artists. This makes the process time consuming and requires lot of effort from the skilled artist. Consequently, the cost of generating photorealistic image becomes very high and non-affordable for many online and offline commerce companies.

U.S. Pat. No. 6,727,925 describes a system for designing a room using a browser connected to a remote system. The patent allows a user to interactively and independently manipulate simplified images of furnishing in a perspective view of a room displayed by a browser. After customization, the user can have the room rendered with substantially photorealistic perspective images of the furnishings. However, the process of rendering the substantially photorealistic perspective images of the furnishings is done manually.

U.S. Pat. No. 8,930,844 describes a method for remote rendering of photorealistic images upon a computer network using 3D models and/or textures. The photorealistic images are rendered and fine-tuned by design professionals at client computers.

U.S. Pat. No. 7,277,572 describes a method and system for generating and rendering a photorealistic three-dimensional (3D) perspective view of a 3D object selectively positioned within a 3D scene. The 3D scene may be selectively displayed in a plurality of views, and a 3D object may be retrieved from a server and imported into the 3D scene to generate a composite. The 3D object may also be manipulated within the composite for placement and orientation. A 3D image of the composite may then be rendered at the client and selectively reconfigured in real time. However, the rendering of 3D image is not automatic and performed manually.

Due to the manual rendering of photorealistic images, the processing time is very high and requires lot of effort from the skilled artist. Consequently, the cost of generating photorealistic image becomes very high and non-affordable for many online commerce websites. Because of the foregoing deficiencies, consumers tend not to purchase the products like furniture and other furnishings, apparels, etc. online. Rather, they tend to insist on actually seeing and trying these products in, for example, a showroom of a traditional “brick and mortar” store. As a result, online sale of these items still lags and have not realized their full potential.

Based upon the foregoing there has been found a need for a system and method for rendering photorealistic visuals (image, video or GIF) quickly in an automated manner.

### SUMMARY OF THE INVENTION

The above mentioned problem is overcome by the present invention which provides a system and method for automatically rendering photorealistic visuals (image, video or GIF) in a quick span of time.

One aspect of the present invention describes a system for rendering photorealistic visuals (image, video or GIF) of a customized 3D scenario. The system includes a 3D interactive application, Customizer, which provides a 3D interactive interface to view a user account, user choices/preferences and a set of stored inspirational 3D models of assets. The 3D interactive interface enables the user to create a customized 3D scenario using the inspirational 3D models and user specific inputs. The customized 3D scenario information is stored in the Customizer. The system also includes an Image Generator which receives the customized 3D scenario information from the Customizer and renders photorealistic visuals by creating a replica of the customized 3D scenario. The rendered photorealistic visuals are sent to the user via email or any other suitable means.

One aspect of the present invention describes a method for rendering photorealistic visuals (image, video or GIF) of a customized 3D scenario. The method includes activating a 3D interactive application, Customizer, which provides a 3D interactive interface to view a user account, user choices/preferences and a set of stored inspirational 3D models of assets. The method also includes creating a customized 3D scenario using the inspirational 3D models and user specific inputs and storing the customized 3D scenario information. The method further includes submitting the customized 3D scenario information to an image generator which renders photorealistic visuals by creating a replica of the customized 3D scenario. The method also includes sending the rendered photorealistic visuals to the user via email or any other suitable means.

Another aspect of the present invention describes a method for generating photorealistic visuals of a customized scenario in a virtual cloud environment. The method comprises generating a 3D scene using 3D models stored in an inspirational database, wherein the 3D scene is generated by a user using a client application running on the cloud virtual environment. The method also comprises importing images of assets from a first database by the user using the client application and processing the images by an image processor to identify one or more objects. The method further comprises tagging the identified objects with one or more tags by the image processor and retrieving one or more 3D models of products similar to the assets from a second database using the tags. The method still further comprises manipulating the 3D models of the products in the 3D scene to generate a composite 3D scene and automatically rendering a photorealistic visual of the composite scene by an image generator.

One more aspect of the present invention describes a system for generating photorealistic visuals of a customized scenario in a virtual cloud environment. The system comprising an inspirational database which stores 3D models for generating a 3D scene and a first database which stores images of one or more assets. The system also comprises a second database which stores one or more 3D models of products similar to the images of the assets. The system further comprises an image processor which performs the steps of processing the images of the assets to identify one or more objects, tagging the identified objects with one or more tags and retrieving one or more 3D models of the products similar to the assets from the second database using the tags. The system still further comprises an interactive client application which enables a user to perform the steps of generating the 3D scene using the 3D models stored in the inspirational database and manipulating the 3D models of products in the 3D scene to generate a composite 3D scene. The system also comprises an image generator which renders a photorealistic visual of the composite image.

### BRIEF DESCRIPTION OF THE DRAWINGS

FIG. 1 illustrates a block diagram of a system embodying the teachings of the present invention;

FIG. 2 illustrates a block diagram showing various modules of a Customizer;

FIG. 3 illustrates a flowchart showing steps in an exemplary method for generating photorealistic visuals (image, video or GIF) of a personalized scenario according to an embodiment of the invention.

FIG. 4 illustrates a flowchart showing steps in an exemplary method for using asset images from an external source for creating a room space according to an embodiment of the invention.

FIG. 5 shows an exemplary image of a room space having different assets.

FIG. 6 illustrates an exemplary 3D model of a living room space.

FIG. 7 illustrates the customized 3D model of the living room as shown in FIG. 6.

FIG. 8 illustrates the finalized 3D scene of the living room as shown in FIG. 7.

FIG. 9 illustrates an exemplary photorealistic image of the finalized 3D scene as shown in FIG. 8.

While the disclosed subject matter is amenable to various modifications and alternative forms, specifics thereof have been shown by way of example in the drawings and will be described in detail. It should be understood, however, that the intention is not to limit aspects of the invention to the particular embodiments described. The intention is to cover all modifications, equivalents, and alternatives falling within the spirit and scope of the invention.

### DETAILED DESCRIPTION OF THE INVENTION

The following detailed description is made with reference to the figures. Exemplary embodiments are described to illustrate the subject matter of the disclosure, not to limit its scope, which is defined by the claims. Those skilled in the art will recognize that the various elements described and/or shown may be arranged in various combinations and configurations without departing from the scope of the disclosure.

All numbers or values are herein assumed to be modified by the term “about.” The disclosure of numerical ranges by endpoints includes all numbers subsumed within that range (e.g., 1 to 5 includes 1, 1.5, 2, 2.75, 3, 3.80, 4, and 5).

As used in this specification and the appended claims, the singular indefinite articles “a”, “an”, and the definite article “the” should be considered to include or otherwise cover both single and plural referents unless the content clearly dictates otherwise. In other words, these articles are applicable to one or more referents. As used in this specification and the appended claims, the term “or” is generally employed to include or otherwise cover “and/or” unless the content clearly dictates otherwise.

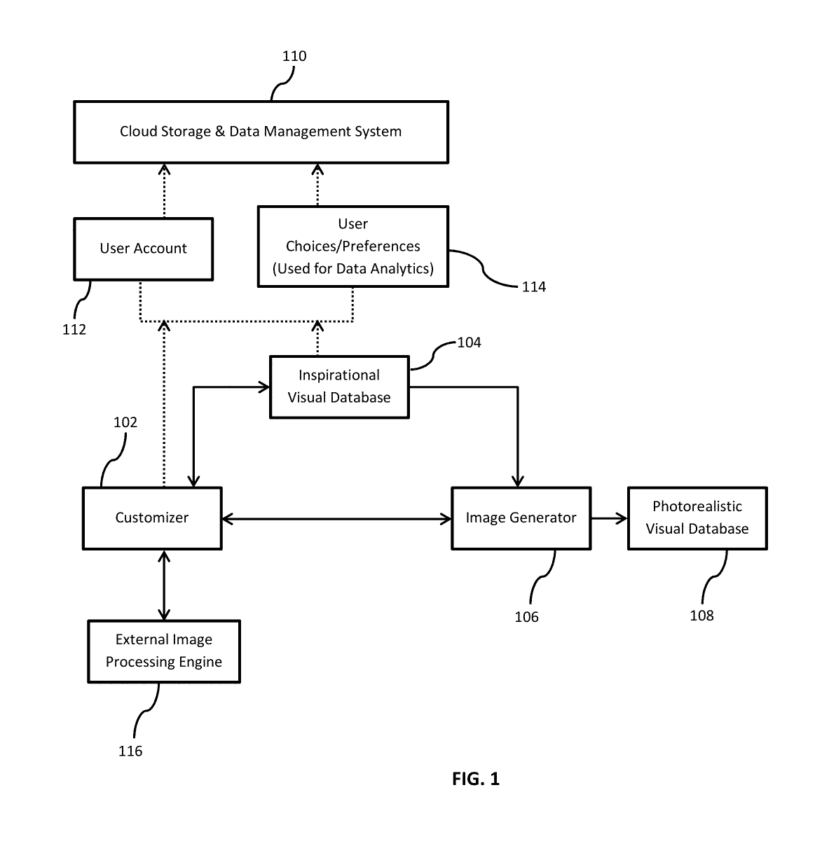

FIG. 1 illustrates a block diagram of a system embodying the teachings of the present invention. The system is explained with reference to the creation of photorealistic visuals (image, video or GIF) of the furnishings in a home/office environment. However, the scope of system is not limited to furnishings but also applicable to verticals like apparels, wall paper, rugs and many more.

A Customizer 102 is a 3D interactive application which enables a user to recreate his/her home environment using simple user experience and visualize home assets in the space. The Customizer 102 runs on a communication device (not shown in fig.) and provides a 3D interactive interface. Exemplary communication device includes a server computer, a client user computer, a personal computer (PC), a tablet PC, a laptop computer, a desktop computer, a mobile phone, a control system, a network router, switch or bridge, or any other device capable of executing the 3D interactive application Customizer 102. In a preferred embodiment of the present invention, the Customizer 102 is built on a game or graphics engine.

The Customizer 102 provides an interactive interface for setting up a user account 112 and user choices/preferences 114 of the assets. The user account 112 stores the personal details of the user like name, age, gender, place of residence, contact information, etc. and creates a profile of the user. The user account 112 is also linked with user choices/preferences 114. The user choices/preferences 114 are either inputted directly by the user or created from the past browsing or purchasing pattern. The user choices/preferences 114 are also created based on the information like user's gender, age group, place of residence, etc. The user choices/preferences 114 can also be used for analyzing the data and providing personalized recommendations to the user. The user account 112 information and user choices/preferences 114 are stored in a Cloud Storage & Data Management System 110 in a virtual cloud environment. It should be clearly understood that the user account 112 information and the user choices/preferences 114 can also be stored in one or more of a server computer, a client user computer, a personal computer (PC), a tablet PC, a laptop computer, a desktop computer, a mobile phone, a control system and a network router, switch or bridge.

The Customizer 102 is connected to an Inspirational Visual Database 104. The Inspirational Visual Database 104 stores a number of inspirational 3D models of the assets which can be used by the user to create his/her room environment. The inspirational 3D models are created using 3D computing technology. Alternatively, the inspirational images and/or videos can also be taken from one or more of a server computer, a client user computer, a personal computer (PC), a camera device, a World Wide Web database, etc., converted into 3D models and uploaded on the Inspirational Visual Database 104. The exemplary databases of the World Wide Web include images sources like Houzz, Pinterest, Google Images, etc.

A 3D model is a mathematical representation of something three-dimensional. 3D models are used to portray real-world and conceptual visuals for art, entertainment, simulation and drafting and are integral to many different industries, including virtual reality, video games, 3D printing, marketing, TV and motion pictures, scientific and medical imaging and computer-aided design and manufacturing CAD/CAM. Some 3D models define surfaces through shaders, programs that mathematically define color, lightplay and other surface characteristics. Other models define color, specularity, surface texture, and light emission through a series of 2D image files called maps, especially those used in games where raster graphics are needed to deliver real-time frame rates.

In the exemplary embodiment of the home furnishing, the Inspirational Visual Database 104 stores 3D models of assets like sofa, table, chair, carpet, doors, windows, etc. The Inspirational Visual Database 104 is linked with the user account 112 and the user choices/preferences 114 and stored in the Cloud Storage & Data Management System 110 of the exemplary embodiment.

The Inspirational Visual Database 104 stores 3D models of assets with high fidelity (high Level of Detail (LOD)). This version of assets is typically meant for photorealistic rendering and movies. The idea for using high fidelity assets is to keep the asset as detailed as possible, keeping in mind optimization best practices. In a preferred embodiment of the present invention, the high LOD consists of the following parameters:

Polygon count—25,000 to 10,00,000 polygons
Texture size (image resolution)—512×512 pixels to 4096×4096 pixels
Material—High quality material/shader applied to the assets. For example, the material/shader applied is a ‘cycles’ shader (Cycles is an open-source rendering engine).

The Inspirational Visual Database 104 can also store 3D models of assets with low Level of Detail (LOD). This version of assets is typically meant for real-time rendering, games, etc. The idea for using low LOD is to keep the assets as optimized and light as possible. In a preferred embodiment of the present invention, the high LOD consists of the following parameters:

Polygon count—7,000 to 30,000 polygons
Texture size (image resolution)—256×256 pixels to 1024×1024 pixels
Material—Low quality material/shader applied to the assets. For example, the material/shader applied is local to the engine in which the asset is being rendered.

The preferred embodiment of the present invention uses assets of high fidelity from the Inspirational Visual Database 104 for creating the room environment. The use of high fidelity assets enhances user experience and enables him/her to have more realistic view of the room environment he/she is creating.

The Inspirational Visual Database 104 can be a dynamic or a static database. In dynamic state, the assets of Inspirational Visual Database 104 are updated based on the user choices/preferences 114 and the user browsing or purchasing pattern. In static state, the assets of Inspirational Visual Database 104 are not updated according to the user choices/preferences 114. However, in the static state, the user can manually update the Inspirational Visual Database 104 with new 3D models.

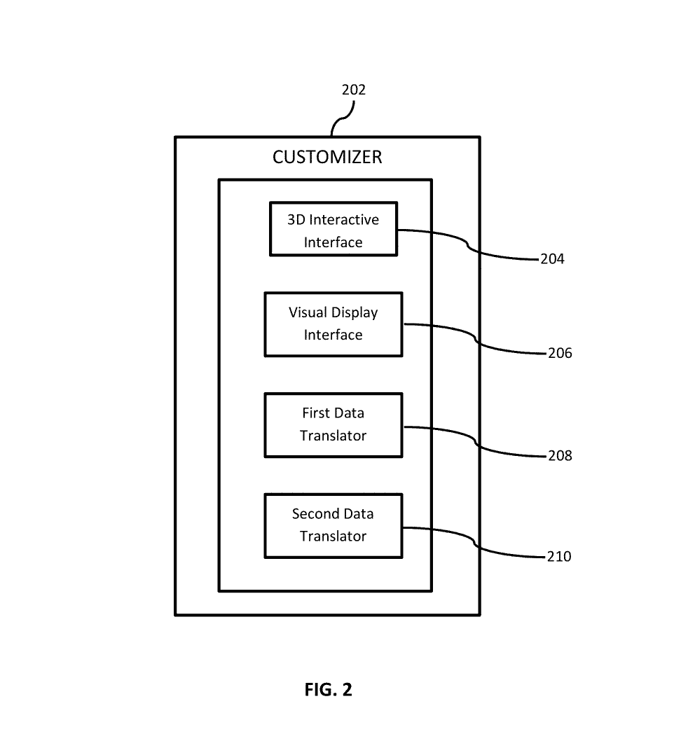

FIG. 2 illustrates the various modules of the Customizer 202. The 3D interactive interface 204 enables the user to setup user account 112 (shown in FIG. 1) and input/update the user choices/preferences 114 (shown in FIG. 1) in the Cloud Storage & Data Management System 110 (shown in FIG. 1). The inspirational 3D models are displayed to the user on the visual display interface 206. The user can work on the 3D interactive interface 204 and create a customized home environment using inspirational 3D models. The 3D interactive interface 204 provides 360 degree freedom and customization options to the user to move and edit the 3D models within the home environment space. The user can also input various parameters like asset positional data, asset orientation data and environmental lightning information to customize the home environment. For example, the user can input the living room dimensions, i.e. 10 feet×13 feet, door and window positions, etc. Alternatively, in the interactive application of the Customizer 102, the user can drag and drop the stored inspirational 3D models of a living room and can also make structural changes to the room. For example, the user can:

Edit walls (height, thickness, width)
Delete a wall
Add/edit/delete free-standing structures and partitions
Add/edit/delete doors & windows
Add/edit/delete step-downs/step-ups
Add/edit/delete slant roofs, ledges and cavities
Add/edit/delete color and texture of walls and objects

It should be clearly understood that the above mentioned parameters are exemplary in nature and does not limit the scope of the invention. The user can make various changes to the room within the scope of the invention.

A first data translator 208 extracts a number of parameters from the asset 3D models and stores in form of .json (JavaScript Object Notation) file. Alternatively, the parameters can also be stored in form of .xml (Extensible Markup Language), .txt or any other suitable format. In an exemplary embodiment, the parameters can be the color of the environment like wall (white), floor (grey granite tiles) and ceiling colors. The parameters can also be the textures (color variants), positions (x, y coordinates) and orientations (angular position in their respective x, y coordinates) of the assets.

A second data translator 210 merges all the inputs (including provided by the user and extracted from the asset 3D models) and creates a 3D room environment. The created 3D room environment is displayed to the user through the visual display interface 206. The user can further customize the 3D room environment by moving and editing the assets through 3D interactive interface 204. After the finalization of changes, the second data translator 210 save and store the 3D room environment setup information in form of a .json file. In an alternative embodiment of the present invention, the 3D room environment setup information can also be stored in form of .xml (Extensible Markup Language), .txt or any other suitable format.

Referring back to FIG. 1, the Customizer 102 provides an option to the user to view the customized 3D room environment in a photorealistic manner through the Image Generator 106. The user can select the option of viewing the photorealistic visual through the 3D interactive interface 204 and can navigate in the 3D room environment using an in-built camera of the Customizer 102. The user can also define the position and viewing angle from which he/she would like to see the photorealistic view. In an exemplary embodiment, the user can define the following parameters:

Type of visuals, i.e., image, video, GIF, interactive view, etc.
Resolution of visual generated
Depth of field and camera parameters

The Image Generator 106 receives the 3D room environment setup information sent by the Customizer 102 in form of .json file. Alternatively, the 3D room environment setup information can also be sent by Customizer in form of .xml (Extensible Markup Language), .txt or any other suitable format. In an exemplary embodiment of the present invention, the .json file sends information about:

Names of objects in the scene, their respective final positions and orientations
Final wall colors and floor colors chosen
Lighting information. i.e. Time of day
Material/shader on the assets
Camera angle
Details of the user (Name, email ID, etc.)

The Image Generator 106 processes the .json file and creates replica of the 3D room environment setup in a rendering engine. The setup is then rendered into a photorealistic visual (image/video/GIF) of the 3D room environment setup and sent to the user. In a preferred embodiment of the present invention, the Image Generator 106 is located in the Cloud Storage & Data Management System 110 and the photorealistic visual is rendered on the cloud computing platform within 30-45 minutes using the following hardware specification:

Amazon Web Services EC2 instance
g2.8×large
CPU Xeon ES-2670 vCPU 32 60 Gb Ram

### GPU GRID Series 4×K520 32 Gb (GPU Ram)

In an alternative embodiment of the present invention, the photorealistic visual (image/video/GIF) is rendered in a superfast manner within 2 minute time period using the following hardware specification:

### NVIDIA GRID VCA

### 8 Kepler GPU's (4 GB FB ea)

CPU threads 16
System memory 192 GB

Alternatively, the photorealistic visuals (image/video/GIF) can also be rendered on a server computer, a client user computer, a personal computer (PC), a tablet PC, a laptop computer, a desktop computer, a mobile phone, a control system, a network router, switch or bridge. The photorealistic image/video/GIF is sent to the user through an email or any other suitable means.

In a particular embodiment of the present invention, the process of photorealistic visuals rendering can be done using multi-threading functionality of the Image Generator 106. The Image Generator 106 assigns the task of visual rendering to multiple instances on the cloud environment so the visual is processed/rendered simultaneously by utilizing the computing power of multiple processors/systems on the cloud (not shown).

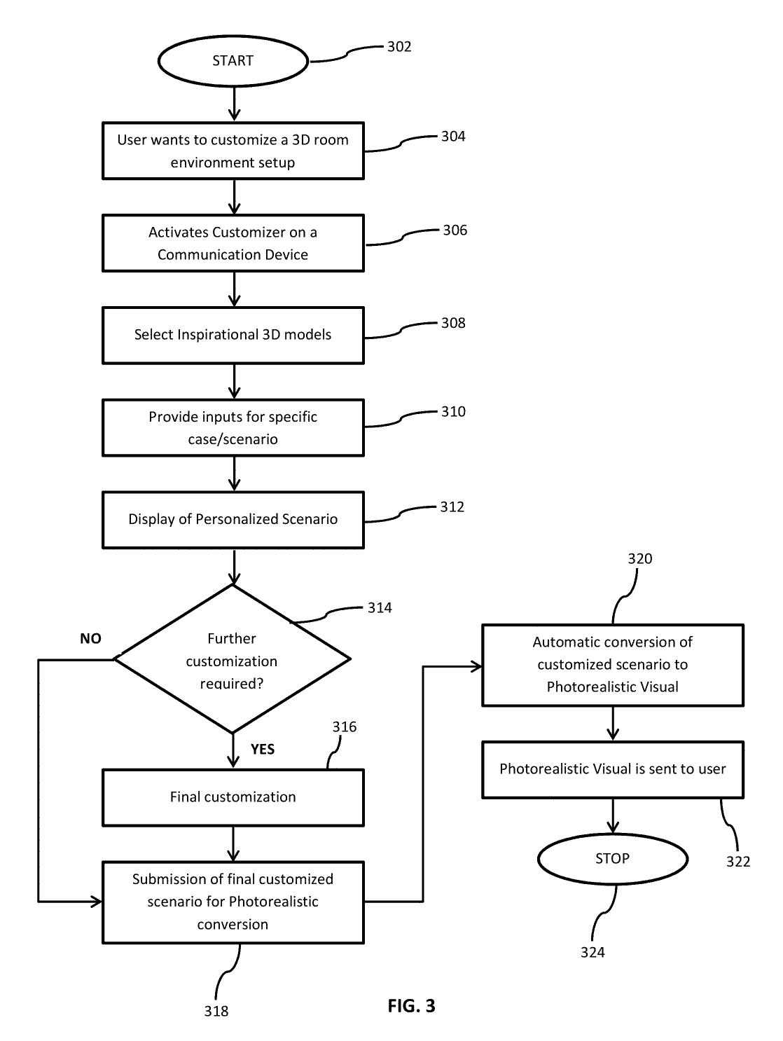

FIG. 3 illustrates a flowchart showing method steps for generating photorealistic visuals (image, video or GIF) of a personalized scenario in an automated manner. The process starts at step 304 with the user's requirement of customizing a 3D room environment setup and visualizing assets in a personalized manner. To process the requirement, the user activates the 3D interactive application, Customizer 102 (shown in FIG. 1), on a communication device (not shown in fig.) at step 306. The Customizer 102 is the 3D interactive application running on the virtual cloud environment of the Cloud Storage & Data Management System 110. Alternatively, the Customizer 102 application can be stored in a remote server. The user can download the application on its local computer or mobile device. The Customizer 102 (shown in FIG. 1) provides a 3D interactive interface 204 (shown in FIG. 2) to view the user account 112 (shown in FIG. 1) and user choices/preferences 114 (shown in FIG. 1). The Customizer also shows a set of inspirational 3D models stored in the Inspirational Visual Database 104 (shown in FIG. 1). At step 308, the user selects inspirational 3D models to create the customized 3D room setup. The user can also use the images and/or videos stored on a local or remote computer or from a World Wide Web database to create the customized 3D room setup. At step 310, the user provides inputs for specific case/scenario according to his/her requirement. For example, the user can input room dimensions, door and window positions in the room, etc. The Customizer 102 (shown in FIG. 1) merges user specific inputs and information from inspirational 3D models and creates the customized 3D room setup. The customized 3D room setup is displayed to the user through Visual Display Interface 206 (shown in FIG. 2) at step 312.

At step 314, the user checks if the customized 3D room setup if final or further customization is required. In case the further customization is not required, the user saves and submits the final customized 3D room setup to Image Generator 106 (shown in FIG. 1) for photorealistic conversion at step 318. Else, at step 316, the user makes required edits and moves of the assets in the 3D room space and finalizes the setup. At step 320, the Image Generator 106 (shown in FIG. 1) creates replica of the 3D room environment setup in a rendering engine. The setup is then rendered into a photorealistic image/video/GIF of the 3D room environment setup and sent to the user via email or any other suitable means at step 322. The process is completed and stops at step 324.

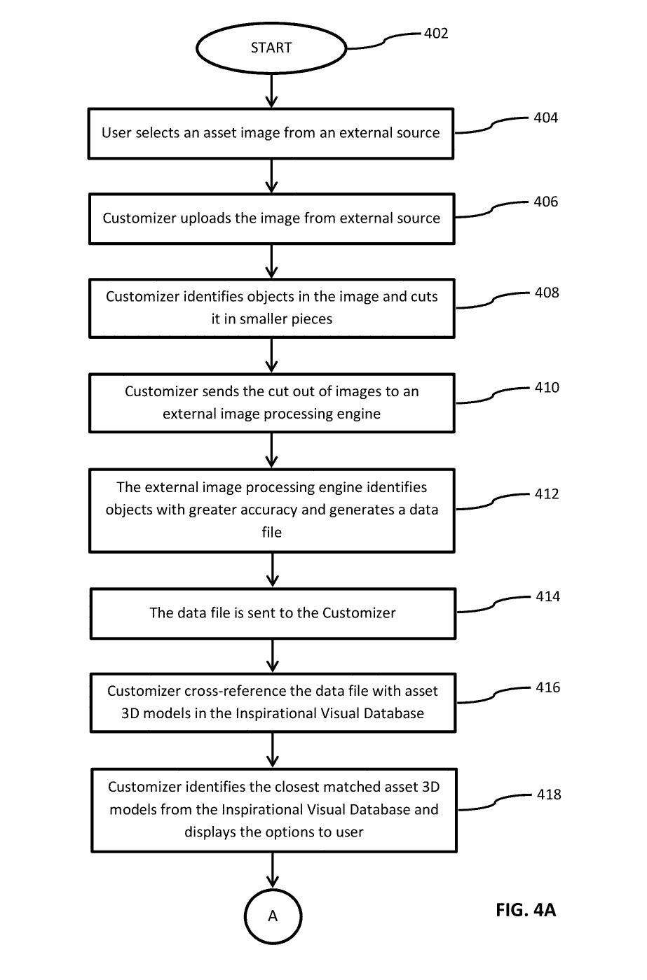

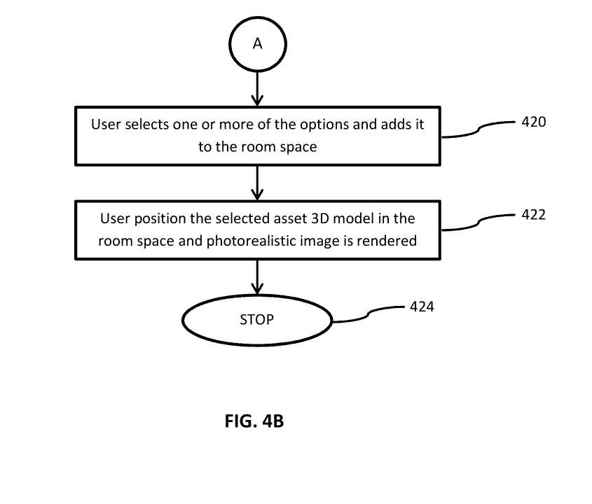

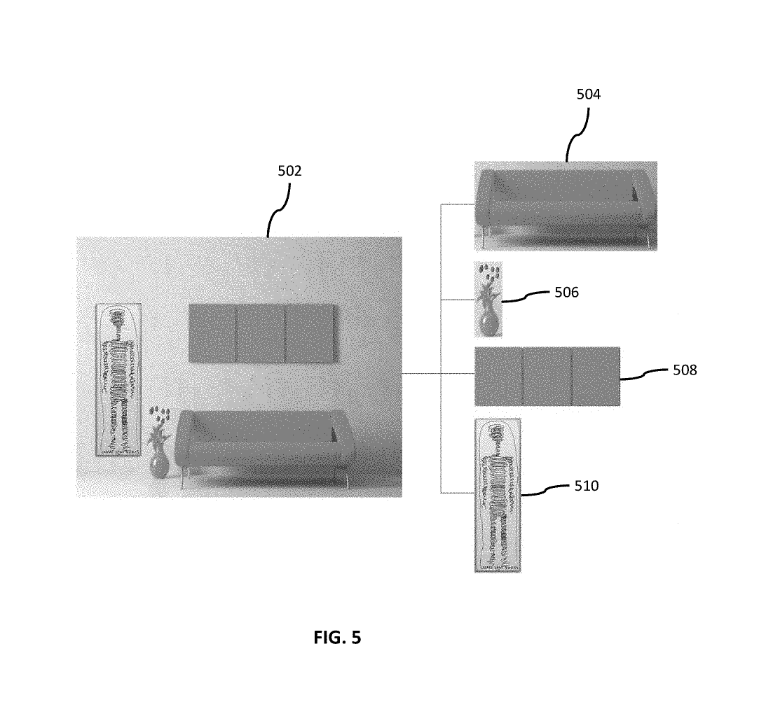

FIG. 4 illustrates a flowchart for an exemplary embodiment of the present invention when the user likes the image of an asset from an external source, like Google Images, images from any website, images stored in a local computer, etc. and wants to use it for designing the room space. The process starts at step 402 and the user selects the asset image from the external source at step 404. The user interacts with the Customizer 102 and uploads the image from the external source for pre-processing at step 406. In a preferred embodiment of the present invention, the pre-processing is done in the virtual cloud environment. At step 408, the Customizer 102 identifies the objects in the image and cuts the image into smaller pieces basis the different products/elements present in the image. FIG. 5 shows an exemplary image of a room space 502 having different assets like a sofa, a flower pot, a painting and wall tiles. The Customizer 102 identifies the different objects and cuts the image 502 it into smaller pieces 504, 506, 508 and 510.

To improve the overall efficiency and accuracy of image recognition, the cut out of images are sent to an external image processing engine 116 at step 410. The external image processing engine 116 can be running on a virtual cloud environment, an external server or a local computer or mobile device. At step 412, the external image processing engine 116 recognizes the objects in the image with greater accuracy and generates a data file in .json, .txt, .xml, or any other suitable format. The generated data file contains a list of all the objects in the image along with their specific tags. For example, if a bath-tub has been recognized, the data file will contain the following tag:

Object 1—bathtub, oval, 4-legged, white

The external image processing engine 116 here refers to any available image processing hardware or software available in the market. As an example, the external image processing engine 116 is Watson, an IBM image processing API. The functionality of external image processing engine 116 is widely known in the art and its details are not disclosed to maintain brevity of the invention.

In order for the Customizer 102 and the external image processing engine 116 to recognize images, the Software program in these systems need to be trained in order to understand the inputs fed to them. A training process is necessary for image processing to be accurate. The training material can be generated at scale using the Inspirational Virtual Database 104 and the Image Generator 106. Every time a high fidelity asset image is added to the Inspirational Virtual Database 104, the asset image is automatically sent to the Image Generator 106. The Image Generator 106 renders multiple images of the asset from several angles with different backgrounds. These rendered images are then automatically uploaded into the Customizer 102 and the external image processing engine 116 in their respective classifier/category.

At step 414, the generated data file is sent to the Customizer 102. The Customizer 102 reads the data file, understands the object tags and cross reference this with asset 3D models stored in the Inspirational Visual Database 104 at step 416. The Customizer 102 identifies the closest matched Inspirational 3D models and displays the options to the user at step 418. The user can select one or multiple 3D models from the displayed options and adds it to the room space at step 420. The user can then position the selected asset 3D models in the room space and render the photorealistic visual at step 422. The process stops at step 424 with the rendered photorealistic visual. The user can also opt to discard all the available options and can freshly select another product image from some external source to repeat the process.

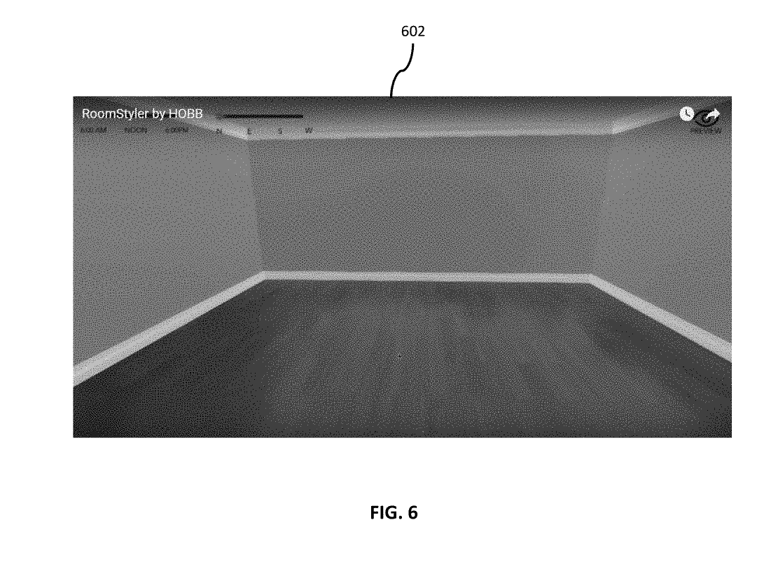

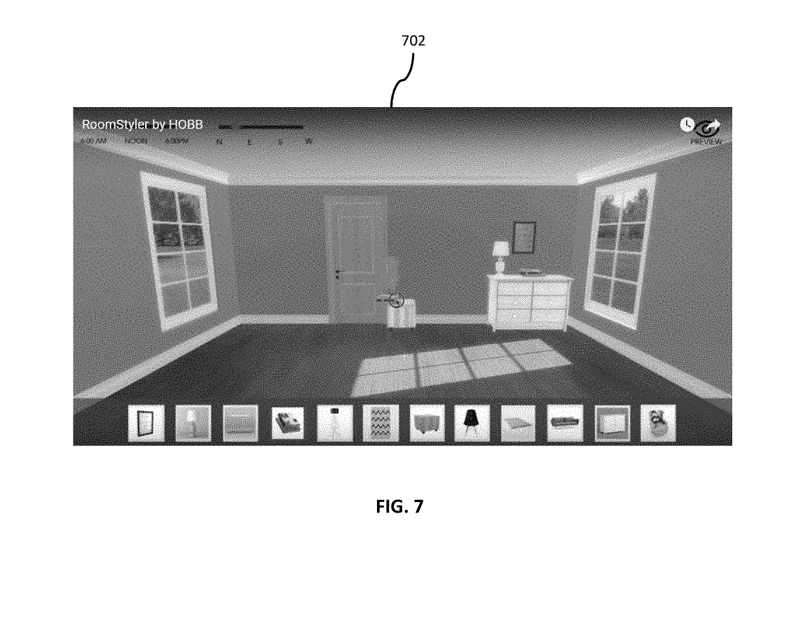

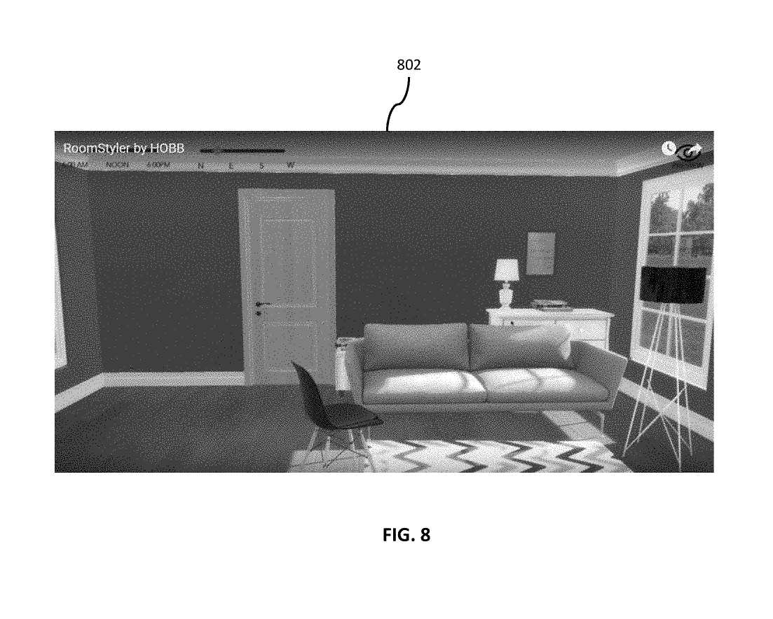

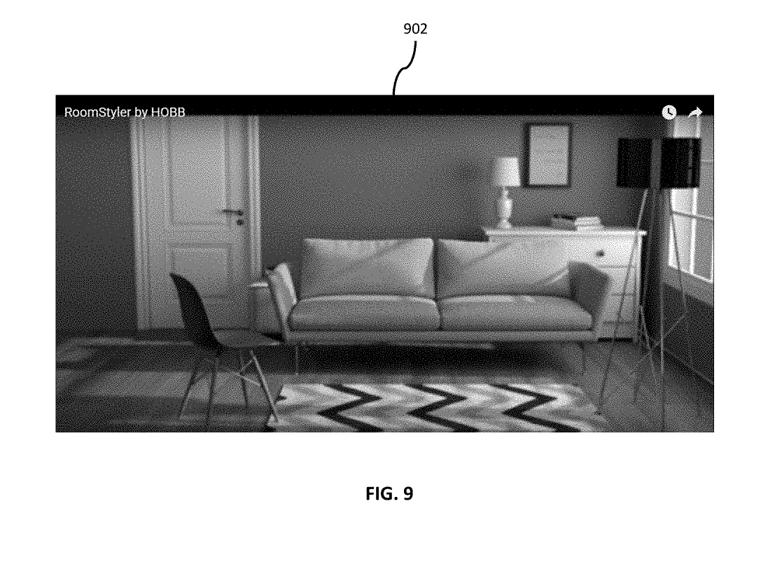

FIG. 6 illustrates an exemplary 3D model of a living room space 602. The living room space 602 is selected by the user from the Inspirational Visual Database 104 using the 3D interactive interface 204 of Customizer 102. The user can drag and drop 3D models of assets from the Inspirational Visual Database 104 to design its living room as shown in FIG. 7. The user has also added lightning effects to the living room. The lightning effects are provided as options by the Customizer 102 according to the time of the day and the direction of light entering the living room. FIG. 8 shows the finalized 3D scene created by the user according to his/her requirement. The finalized 3D scene is sent by the Customizer 102 to the Image Generator 106 which automatically renders the photorealistic image of the scene as shown in FIG. 9. The time taken for photorealistic image generation can vary depending upon the resolution and size of the images used for generating the finalized 3D scene. The photorealistic image is displayed to the user on the visual display interface 206 of the Customizer 102. The user can also opt to download the generated photorealistic image on a local computer or mobile device. Further, the Customizer 102 can also provide option to the user to receive the photorealistic image through email.

1. A method for generating photorealistic visuals of a customized scenario in a virtual cloud environment, the method comprising:
generating a 3-dimensional (3D) scene using one or more 3D models stored in an inspirational database, wherein the 3D scene is generated by a user using a client application running on the cloud virtual environment;
importing images of one or more assets from a first database, wherein the images are imported by the user using the client application;
processing, by an image processor, the images of the one or more assets to identify one or more objects;
tagging, by the image processor, the identified one or more objects with one or more tags;
retrieving, by the image processor, one or more 3D models of products similar to the one or more assets from a second database using the one or more tags;
manipulating, by the user using the client application, the one or more 3D models of the products in the 3D scene to generate a composite 3D scene; and
automatically rendering, by an image generator, a photorealistic visual of the composite 3D scene.

2. The method of claim 1, wherein said manipulating comprises positioning the one or more 3D models of products in the 3D scene by the user using the client application.

3. The method of claim 1, wherein the rendered photorealistic visual of the composite 3D scene is displayed to the user on a display of the client application.

4. The method of claim 1, wherein the rendered photorealistic visual of the composite 3D scene can be downloaded on a local device of the user.

5. The method of claim 1, wherein the 3D scene, the one or more 3D models of the products and the composite 3D scene are high fidelity models.

6. The method of claim 1, wherein the second database is a part of the inspirational database.

7. The method of claim 1 further comprises adding luminosity characteristics on the composite 3D scene.

8. A system for generating photorealistic visuals of a customized scenario, the system comprising:
an inspirational database, wherein the inspirational database stores one or more 3-dimensional (3D) models for generating a 3D scene;
a first database, wherein the first database stores images of one or more assets;
a second database, wherein the second database stores one or more 3D models of products similar to the images of the one or more assets;
an image processor, wherein the image processor performs the steps of:
processing the images of the one or more assets to identify one or more objects;
tagging the identified one or more objects with one or more tags; and
retrieving one or more 3D models of the products similar to the one or more assets from the second database using the one or more tags;
an interactive client application, wherein the interactive client application enables a user to perform the steps of:
generating the 3D scene using the one or more 3D models stored in the inspirational database; and
manipulating the one or more 3D models of the products in the 3D scene to generate a composite 3D scene; and
an image generator, wherein the image generator automatically renders a photorealistic visual of the composite 3D scene.

9. The system of claim 8, wherein the system is stored in a virtual cloud environment.

10. The system of claim 8, wherein the interactive client application further comprises a display for displaying the rendered photorealistic visual of the composite 3D scene.

11. The system of claim 8, wherein the interactive client application further enables the user to download a copy of the rendered photorealistic visual of the composite 3D scene on its local device.

12. The system of claim 8, wherein the 3D scene, the one or more 3D models of the products and the composite 3D scene are high fidelity models.

13. The system of claim 8, wherein the second database is a part of the inspirational database.

14. The system of claim 8, wherein the interactive client application further enables the user to add luminosity characteristics on the composite 3D scene.
